(19) United States
(12) Patent Application Publication
(10) Pub. No.: US 2013/0021564 A1
(43) Pub. Date: Jan. 24, 2013

(54) LIQUID CRYSTAL DISPLAY DEVICE

(71) Applicants: Yasutoshi Tasaka, Osaka (JP); Keisuke Yoshida, Osaka (JP); Yuki Kawashima, Osaka (JP); Kaori Saitoh, Osaka (JP); Mutsumi Nakajima, Osaka (JP)

(72) Inventors: Yasutoshi Tasaka, Osaka (JP); Keisuke Yoshida, Osaka (JP); Yuki Kawashima, Osaka (JP); Kaori Saitoh, Osaka (JP); Mutsumi Nakajima, Osaka (JP)

(73) Assignee: SHARP KABUSHIKI KAISHA, Osaka (JP)

(21) Appl. No.: 13/637,315

(22) PCT Filed: Nov. 24, 2010
(86) PCT No.: PCT/JP2010/070918

§ 371 Date: Sep. 25, 2012

(30) Foreign Application Priority Data
Mar. 26, 2010 (JP) 2010-072915

(51) Int. Cl. G02F 1/1335

(52) U.S. Cl. 349/96

(57) ABSTRACT

A pixel electrode (1) has a frame portion (6) along the entire inner circumference of a pixel (10). The frame portion (6) is provided with a plurality of fine electrodes (7a to 7d) each disposed to form an angle of 45 degrees to the polarization axis of a linear polarizing plate. The pixel electrode (1) has a slit (8) formed in a portion other than the frame portion (6) and the fine electrodes (7a to 7d), i.e., the center portion. When the pixel electrode (1) is applied with a voltage, liquid crystal molecules (4) are oriented in four different directions along the fine electrodes (7a to 7d). Furthermore, by the effects from the frame portion (6) along the entire inner circumference of the pixel (10), the liquid crystal molecules (4) are tilted from the center of the pixel electrode (1) toward the outer circumference of an opposite electrode. That is, the liquid crystal molecules (4) are oriented in the four different directions while tilting from the center of the pixel electrode (1) toward the outer circumference of the opposite electrode.

### TECHNICAL FIELD

The present invention relates to a liquid crystal display device, and more particularly, to a vertical alignment type liquid crystal display device having a plurality of domains for orientation division in a pixel.

### BACKGROUND ART

In recent years, thin-profile flat panel displays (FPDs) have been widely used for display devices, replacing cathode ray tubes that were traditionally used in most display devices. The FPDs use liquid crystals, light-emitting diodes (LEDs), organic electroluminescence (organic EL), or the like as display elements thereof. Among them, a display device using liquid crystals has advantages of thin-profile, light-weight, and low power consumption, and therefore, the research and development thereof have been actively pursued.

As a driving method of a liquid crystal display device (LCD), a method of using an active matrix (AM) circuit having thin-film transistors (TFTs) is used. The AM circuit is a switching circuit that controls each pixel to switch between display and non-display states. Because the AM circuit controls each pixel individually, even if the number of wiring lines in the display device is increased, each pixel can be operated reliably. Therefore, in the LCD utilizing the AM circuits, it is possible to achieve higher resolution, clearer contrast, and faster response speed.

Among LCDs utilizing the AM circuits, TN (Twisted Nematic) type LCDs are well known. In the TN type LCD, a pair of linear polarizing plates are disposed on outer surfaces of two substrates, respectively, in a crossed Nicols state. When linear polarized light enters a liquid crystal layer through one polarizing plate, the polarizing axis thereof is rotated by the optical polarity rotation and the birefringence of liquid crystal molecules, allowing the light to pass through the other polarizing plate. If a voltage is applied between a pixel electrode and an opposite electrode, the liquid crystal molecules are vertically aligned (become perpendicular) with respect to the surfaces of the two substrates. As a result, linear polarized light that entered the liquid crystal layer directly reaches the opposite side without rotating the polarizing axis thereof, and thus cannot pass through the other polarizing plate.

Because the TN type LCD described above utilizes the birefringence of the liquid crystal molecules, the viewing state varies depending on the position of a viewer relative to the alignment direction of the liquid crystal molecules. That is, the TN type LCD has a problem of a narrow viewing angle and insufficient viewing characteristics.

To solve this problem, a VA (Vertical Alignment) type LCD in which liquid crystal molecules (liquid crystal molecules having negative dielectric anisotropy) are vertically aligned relative to a substrate has been developed and put into practical use. The VA type LCD is configured to generate an oblique electric field relative to the alignment direction of the liquid crystal molecules. Therefore, when a voltage is applied between a pixel electrode and an opposite electrode, the liquid crystal molecules shift to a tilted position. If a pixel is divided into domains such that the liquid crystal molecules are tilted in a plurality of different directions in a single pixel, the viewing state becomes substantially the same regardless of viewing angle. Such an LCD in which each pixel to be driven is divided into a plurality of domains is referred to as an MVA (Multi-domain Vertical Alignment) type, and has a wider viewing angle and excellent viewing characteristics.

Patent Document 1, for example, discloses an MVA type LCD that is provided with slits. Specifically, in this LCD, by providing control electrodes, pixel electrodes formed in a TFT substrate are maintained in an electrically floating state. The pixel electrodes respectively have X-shaped slits formed therein. By controlling the orientation direction of the liquid crystal molecules through the control electrodes, viewing characteristics of four divided domains formed by the slit are compensated with each other in each pixel, achieving symmetrical and excellent viewing characteristics.

Patent Document 2 discloses an MVA type LCD in which pixel electrodes having a fishbone structure are provided between a pair of linear polarizing plates arranged in a crossed-Nicols state. FIG. 6 shows the fishbone structure in detail. FIG. 6 is a cross-sectional view of a pixel having a pixel electrode of the fishbone structure. In the following description, a direction from the left side to the right side in FIG. 6 is set to an azimuth angle of 0°, and on the basis of this angle, the respective azimuth angles are set in a counterclockwise manner. Specifically, as shown in FIG. 6, the fishbone structure is a structure having a trunk portion 15a extended in a direction of 0°-180° azimuth angles, a trunk portion 15b extended in a direction of 90°-270° azimuth angles, a plurality of branch portions 16a extended in a direction of 45°-225° azimuth angles, and a plurality of branch portions 16b extended in a direction of 135°-315° azimuth angles. With such a pixel electrode 11, a single pixel is divided into four domains (multi-domain). Upon voltage application, liquid crystal molecules 4 in the four domains are oriented along the above-mentioned branch portions, respectively. This suppresses orientation anomaly or orientation variations of the liquid crystal molecules 4, thereby making it possible to stably maintain the proper orientation directions of the liquid crystal molecules 4 in each pixel. As a result, it becomes possible to suppress variations in transmittance on a display surface, allowing for high quality display with no roughness.

### RELATED ART DOCUMENTS

### Patent Documents

Patent Document 1: Japanese Patent Application Laid-Open Publication No. 2001-249350 (Published on Sep. 14, 2001)

Patent Document 2: WO 2009/084162 Pamphlet (Published on Jul. 9, 2009)

### SUMMARY OF THE INVENTION

### Problems to be Solved by the Invention

As described above, in the LCD using the pixel electrode of the fishbone structure disclosed in Patent Document 2, the orientation direction of the liquid crystal molecules can be controlled to be 45° relative to the polarizing axis of the polarizing plate. However, in the configuration disclosed in Patent Document 2, the deviation of the orientation directions of the liquid crystal molecules occurs at end portions of each pixel and boundary portions between the respective domains as shown in FIG. 7 in detail. FIG. 7 is a diagram showing the orientation directions of the liquid crystal molecules in the pixel provided with the pixel electrode of the fishbone structure. As shown in FIG. 7, by the effect of the trunk portions of the pixel electrode formed in the center portion of the pixel, orientation directors 18a toward the top and orientation directors 18b toward the bottom in the liquid crystal molecules 4 are increased. As a result, the deviation of the orientation directions of the liquid crystal molecules 4 occurs, causing an imbalance between the vertical orientation and the horizontal orientation of the liquid crystal molecules 4 in each pixel. This causes a balance between gamma characteristics in the vertical direction and gamma characteristics in the horizontal direction to be worsened, resulting in degradation of display quality of the LCD.

Further, the size of a region in which the deviation of the orientation directions of the liquid crystal molecules 4 occurs does not change regardless of pixel pitch. That is, the smaller the pixel pitch is, the larger the effect of the deviation of the orientation directions becomes.

Similarly, in the technology disclosed in Patent Document 1 described above, it is difficult to make the liquid crystal molecules aligned orderly along the X-shaped slit in the proper orientation directions. As a result, the deviation of the orientation directions of the liquid crystal molecules occurs, causing an imbalance between the vertical orientation and the horizontal orientation of the liquid crystal molecules in each pixel. That is, in the technology disclosed in Patent Document 1, the balance of the gamma characteristics is worsened, resulting in the degradation of display quality of the LCD.

In the technology disclosed in Patent Document 1, linear polarizing plates cannot be used as polarizing plates, which worsens the viewing characteristics of the LCD. In this case, retardation plates need to be provided. Also, because it is necessary to form the control electrodes below the pixel electrodes, the structure of the LCD becomes more complex. Further, because the pixel electrodes are in a floating state, a problem of burn-in may be caused by residual electric charges.

The present invention was made in view of the above-mentioned problems, and aims at providing an LCD that can achieve excellent balance of gamma characteristics of the LCD and that thereby has high display quality.

### Means for Solving the Problems

In order to solve the above-mentioned problems, a liquid crystal display device according to the present invention is a vertical alignment type that has a plurality of pixels and a pair of polarizing plates that are disposed such that transmission axes thereof are orthogonal to each other, including: a pixel electrode; an opposite electrode facing the pixel electrode; and a liquid crystal layer disposed between the pixel electrode and the opposite electrode in each of the plurality of pixels, wherein the pixel electrode that is divided into a plurality of domains includes a frame portion along an entire inner circumference of the pixel and a plurality of fine electrode portions each having one end connected to the frame portion and another end separated therefrom, the plurality of fine electrode portions being extended toward an inside of the frame portion, wherein, in each of the domains, the plurality of fine electrode portions provided in the domain are extended in the same direction, and an extending direction thereof differs from an extending direction of the plurality of fine electrode portions provided in another domain, and wherein each of the fine electrode portions is extended in a direction that forms a 45-degree angle with respective extending directions of the transmission axes, and is extended so as to approach the respective extending directions of the transmission axes.

According to this configuration, in each domain of the pixel electrode, the plurality of fine electrode portions that are extended in a direction that forms a 45-degree angle with extending directions of the transmission axes of the polarizing plates are formed. Further, the plurality of fine electrode portions provided in one domain are extended in the same direction, and the extending direction differs from an extending direction of the plurality of fine electrode portions provided in another domain. In this configuration, when a voltage is applied to the liquid crystal layer, the liquid crystal molecules are oriented along the fine electrode portions. Also, by the effect of the frame portion along the entire inner circumference of the pixel, the liquid crystal molecules tilt from the center of the pixel electrode toward the outer circumference of the opposite electrode. That is, the liquid crystal molecules are oriented in the direction that forms a 45-degree angle with the extending directions of the transmission axes of the polarizing plates, while tilting from the center of the pixel electrode toward the outer circumference of the opposite electrode.

The other ends of the fine electrode portions are separated from each other. That is, in the center portion of the pixel electrode, a slit is formed. This makes it possible to prevent the orientation directors of the liquid crystal molecules from being increased in one direction in each pixel, and by the effects of the frame portion and the fine electrode portions of the pixel electrode, the orientation directors of the liquid crystal molecules can be evenly distributed. As a result, the deviation of the orientation directions of the liquid crystal molecules in each pixel can be prevented, which allows for a good balance of the orientation directions of the liquid crystal molecules. This can prevent an imbalance of gamma characteristics resulting from the deviation of the orientation directions of the liquid crystal molecules, and thus, it becomes possible to prevent the display gray scale conditions from varying depending on the viewing angle, thereby further improving the display quality of the display surface.

Further, in the above-mentioned configuration, because light passing through the liquid crystal layer is emitted in a plurality of different directions, the substantially same view can be achieved regardless of viewing angle relative to the display surface.

Additional objects, features, and effects of the present invention shall be readily understood from the descriptions that follow. Advantages of the present invention shall become apparent by the following descriptions with reference to the appended drawings.

### Effects of the Invention

According to the present invention, the slit is formed in the center portion of the pixel electrode, and therefore, the orientation directors of the liquid crystal molecules are evenly distributed by the effects of the frame portion and the fine electrode portions. Therefore, deviation of the orientation directions of the liquid crystal molecules in each pixel is prevented, thereby improving the balance between the orientation directions of the liquid crystal molecules. This can prevent an imbalance of gamma characteristics resulting from the deviation of the orientation directions of the liquid crystal molecules, and thus, it becomes possible to prevent the display gray scale conditions from varying depending on the viewing direction, thereby further improving the display quality of the display surface. Further, according to the present invention, because light passing through the liquid crystal layer is emitted in a plurality of different directions, the substantially same view can be achieved regardless of viewing angle relative to the display surface.

### BRIEF DESCRIPTION OF THE DRAWINGS

FIG. 1 is an enlarged view of a single pixel of a liquid crystal display device according to one embodiment of the present invention.

FIG. 2 is a cross-sectional view showing a single pixel of a liquid crystal display device according to one embodiment of the present invention.

FIG. 3(a) is a graph showing gamma characteristics in the vertical direction of a conventional pixel. FIG. 3(b) is a graph showing gamma characteristics in the horizontal direction of the conventional pixel.

FIG. 4 is a diagram showing orientation directions of liquid crystal molecules in a pixel provided with a pixel electrode according to one embodiment of the present invention.

FIG. 5(a) is a graph showing gamma characteristics in the vertical direction of a pixel according to one embodiment of the present invention. FIG. 5(b) is a graph showing gamma characteristics in the horizontal direction of the pixel according to one embodiment of the present invention.

FIG. 6 is a cross-sectional view of a pixel provided with a pixel electrode of a conventional fishbone structure.

FIG. 7 is a diagram showing orientation directions of liquid crystal molecules in the pixel provided with the pixel electrode of the conventional fishbone structure.

### DETAILED DESCRIPTION OF EMBODIMENTS

(Overview of Liquid Crystal Display Device)

One embodiment of the present invention will be explained with reference to figures. First, an overview of a liquid crystal display device (LCD) according to the present embodiment will be explained.

The LCD of this embodiment is a VA (Vertical Alignment) type LCD in which liquid crystal molecules having negative dielectric anisotropy (ε<0) are aligned vertically to a substrate. The LCD of this embodiment is constituted of a backlight unit and a liquid crystal display element unit. A planar light source device is provided as the backlight unit, and a liquid crystal panel is provided as the liquid crystal display element unit. The liquid crystal panel includes a TFT substrate having thin-film transistors (TFTs), pixel electrodes, and the like, corresponding to respective pixels, and an opposite substrate having a color filter, an opposite electrode, and the like. A liquid crystal layer is sealed between the two substrates. Linear polarizing plates are respectively disposed on an outer side of the TFT substrate (side opposite to the liquid crystal layer) and on an outer side of the opposite substrate (side opposite to the liquid crystal layer), and the two linear polarizing plates are arranged in a crossed Nicols state.

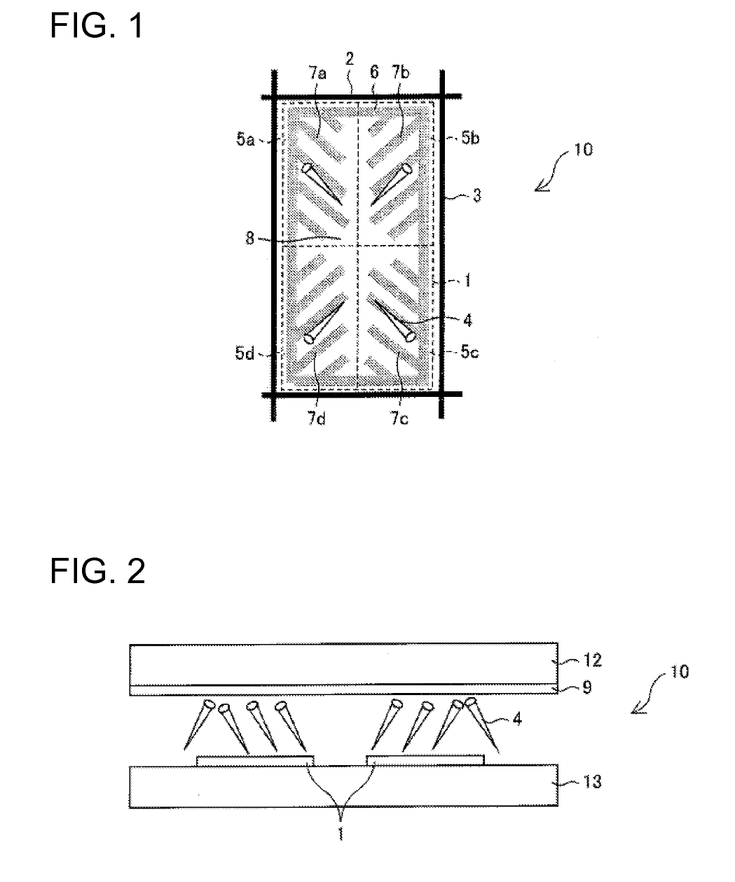

In the TFT substrate, scanning lines (gate bus lines) and signal lines (source bus lines) are formed, and pixel electrodes are formed on the scanning lines and the signal lines through an insulating film. A region enclosed by two adjacent scanning lines and two adjacent signal lines forms a single pixel. The pixel of the LCD according to this embodiment will be explained in detail with reference to FIG. 1. FIG. 1 is an enlarged view of a single pixel 10 of the LCD according to this embodiment.

As shown in FIG. 1, the pixel 10 is enclosed by two adjacent scanning lines 2 and two adjacent signal lines 3. Each pixel 10 is provided with a pixel electrode 1 and a TFT (not shown) for switching a display voltage to the pixel electrode 1. The gate electrode of the TFT is electrically connected to the scanning line 2, and the source electrode of the TFT is electrically connected to the signal line 3. The drain electrode of the TFT is electrically connected to the pixel electrode 1, thereby directly applying the display voltage thereto. By directly connecting the drain electrode of the TFT to the pixel electrode 1 in this way, a loss in the voltage applied to the pixel electrode 1 can be reduced. In the pair of linear polarizing plates respectively disposed on the outer side of the TFT substrate and on the outer side of the opposite substrate, the polarizing axis (transmission axis) of one linear polarizing plate is extended in the horizontal direction in FIG. 1, and the polarizing axis of the other linear polarizing plate is extended in the vertical direction in FIG. 1. That is, each axis is extended in parallel with or perpendicular to one side of the pixel 10. Alternatively, the polarizing axis of each of the pair of linear polarizing plates may be extended in a direction that forms a 45-degree angle with one side of the pixel 10. In the following description, four domains that are formed when the pixel electrode 1 is evenly divided in quarters by a line parallel with the scanning line 2 and a line parallel with the signal line 3 in FIG. 1 are referred to as domains 5a to 5d.

The pixel electrode 1 has a frame portion 6 “along the entire inner circumference” of the pixel 10. “Along the entire inner circumference” means that the frame portion 6 is formed inside of the pixel 10 along a border between the inside and the outside of the pixel 10. In other words, the frame portion 6 is formed inside of the pixel 10 along the four sides of the pixel 10. In the frame portion 6, fine electrodes 7a to 7d (fine electrode portions) each having one end connected to the frame portion 6 and the other end separated therefrom. The fine electrodes 7a to 7d are extended toward inside of the frame portion 6. Specifically, in the domain 5a of the pixel electrode 1, a plurality of fine electrodes 7a that make a 45-degree angle with the frame portion 6 (direction from the domain 5a toward the domain 5c) are formed. In the domain 5b of the pixel electrode 1, a plurality of fine electrodes 7b that make a 45-degree angle with the frame portion 6 (direction from the domain 5b toward the domain 5d) are formed. Similarly, in the domain 5c of the pixel electrode 1, a plurality of fine electrodes 7c that make a 45-degree angle with the frame portion 6 (direction from the domain 5c toward the domain 5a) are formed. In the domain 5d of the pixel electrode 1, a plurality of fine electrodes 7d that make a 45-degree angle with the frame portion 6 (direction from the domain 5d toward the domain 5b) are formed. That is, the plurality of fine electrodes 7a to 7d are formed so as to make a 45-degree angle with the extending directions of the polarizing axes of the linear polarizing plates, respectively. The pixel electrode 1 does not have anything formed therein other than the frame portion 6 and the fine electrodes 7a to 7d. That is, the center portion of the pixel electrode 1 has an opening, forming a slit 8.

(Orientation of Liquid Crystal Molecules 4)

By using the above-mentioned pixel electrode 1, viewing characteristics of an LCD can be improved as described in detail with reference to FIG. 2. FIG. 2 is a cross-sectional view of the pixel 10.

As shown in FIG. 2, between the opposite substrate 12 having the opposite electrode 9 formed therein and the TFT substrate 13 having the pixel electrode 1 formed therein, the liquid crystal layer including the liquid crystal molecules 4 having the negative dielectric anisotropy (ε<0) is formed. When a voltage is applied between the two substrates, an oblique electric field is generated in the liquid crystal layer by the pixel electrode 1 and the opposite electrode 9. Specifically, as shown in FIG. 1, by the effects of the fine electrodes 7a to 7d of the pixel electrode 1, the liquid crystal molecules 4 are oriented along the fine electrodes 7a to 7d (that is, in directions forming a 45-degree angle with the respective polarizing axes of the linear polarizing plates). Also, as shown in FIG. 2, by the effect of the slit 8 in the center portion of the pixel electrode 1, and by the effect of the frame portion 6 along the entire inner circumference of the pixel 10, the liquid crystal molecules 4 are tilted from the center of the pixel electrode 1 toward the outer circumference of the opposite electrode 9. Thus, the liquid crystal molecules 4 are oriented in the four directions that respectively form a 45-degree angle with the polarizing axes of the polarizing plates, while tilting from the center of the pixel electrode 1 toward the outer circumference of the opposite electrode 9.

As described above, the liquid crystal molecules 4 are oriented in the directions that respectively form a 45-degree angle with the polarizing axes of the polarizing plates, and therefore, when linear polarized light enters the liquid crystal layer through one linear polarizing plate, the polarizing axis thereof is rotated by the optical polarity rotation and the birefringence of the liquid crystal molecules 4, allowing the light to pass through the other linear polarizing plate. Further, by dividing the pixel 10 into the four domains 5a to 5d, the liquid crystal molecules 4 are oriented in different directions in the respective domains 5a to 5d, thereby allowing the liquid crystal molecules 4 to be oriented in a plurality of different directions in the single pixel 10. This way, light passing through the liquid crystal layer is emitted in the plurality of different directions, and therefore, it becomes possible to achieve the substantially same view regardless of viewing angle relative to the display surface. Thus, with the above-mentioned configuration, excellent viewing characteristics can be achieved.

When no voltage is applied between the two substrates, the liquid crystal molecules 4 in the liquid crystal layer are vertically aligned to the surfaces of the two substrates. Therefore, linear polarized light that entered the liquid crystal layer reaches the opposite side without rotating the polarizing axis thereof, and thus cannot pass through the other linear polarizing plate.

As described above, in the LCD according to this embodiment, when no voltage is applied, the liquid crystal molecules 4 are vertically aligned to the substrate surfaces, and because the liquid crystal layer thereby becomes non-birefringent, the LCD performs a black display. When a voltage is applied between the substrates, and the liquid crystal molecules are tilted in the directions that respectively form a 45-degree angle with the polarizing axes of the polarizing plates, the LCD performs a white display. If the liquid crystal molecules 4 are tilted in a direction that is parallel with or orthogonal to the polarizing axes upon voltage application, the liquid crystal layer would not become birefringent to the linear polarized light, resulting in a black display. For this reason, it is necessary to control the tilt direction of the liquid crystal molecules 4. According to this embodiment, by using the pixel electrode 1 constituted of the frame portion 6 along the entire inner circumference of the pixel electrode 1 and the plurality of fine electrodes 7a to 7d that respectively form a 45-degree angle with the polarizing axes of the polarizing plates, it becomes possible to make the liquid crystal molecules 4 oriented in the four directions that respectively form a 45-degree angle with the polarizing axes of the polarizing plates with high degree of accuracy.

In the present embodiment, it is not necessary to provide an additional electrode or the like below the pixel electrode 1, for example, to control the orientation direction of the liquid crystal molecules 4, and as a result, the number of constituting members of the pixel 10 can be reduced. When the additional electrode or the like is provided in the pixel 10, it makes it difficult to make the liquid crystal molecules 4 oriented in desired directions. In the present embodiment, it is not necessary to provide an additional electrode or the like below the pixel electrode 1, for example, to control the orientation direction of the liquid crystal molecules 4, and as a result, the number of constituting components of the pixel 10 can be reduced.

In the present embodiment, the pixel electrode 1 is divided into the four domains 5a to 5d, but the present invention is not necessarily limited to this, and as long as a disclination line does not appear with respect to the polarizing axes of the linear polarizing plates, the pixel electrode 1 may be divided into any number of domains. The disclination line is a region where the orientation of the liquid crystal molecules 4 is discontinued, resulting in brightness reduction.

(Gamma Characteristics of Pixel 10)

In an LCD using the pixel electrode disclosed in Patent Document 1 or the pixel electrode of the fishbone structure disclosed in Patent Document 2, for example, upon voltage application, the liquid crystal molecules are tilted from the outer circumference of the pixel electrode toward the center of the opposite electrode. This is because an oblique electric field from the outer circumference of the pixel electrode toward the center of the opposite electrode is generated in the liquid crystal layer by the pixel electrode and the opposite electrode. In such a configuration, deviation of the orientation directions of the liquid crystal molecules occurs at the end portions of each pixel and boundary portions between the respective domains. Specifically, the orientation directors of the liquid crystal molecules in the vertical direction are increased in each pixel. As a result, an imbalance between the vertical orientation and the horizontal orientation of the liquid crystal molecules in each pixel occurs. This causes a balance between gamma characteristics in the vertical direction and gamma characteristics in the horizontal direction to be worsened, resulting in degradation of display quality of the LCD.

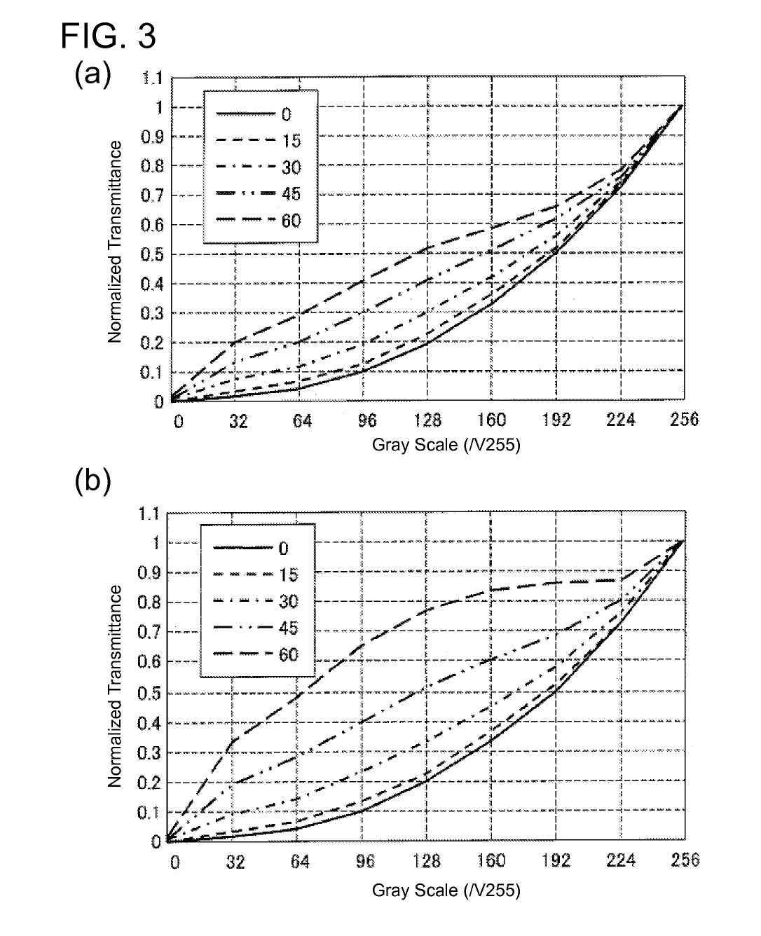

FIG. 3 shows the gamma characteristics in this case. FIG. 3(a) shows gamma characteristics in the vertical direction in each pixel. FIG. 3(b) shows gamma characteristics in the horizontal direction in each pixel. The vertical axis in each figure represents a normalized transmittance with the gray scale voltage V255 being 1. In FIG. 3, gamma characteristics when the display surface is viewed from a frontal direction)(0°), and gamma characteristics when the display surface is viewed diagonally from 15°, 30°, 45°, and 60° are respectively shown.

As shown in FIGS. 3(a) and 3(b), a discrepancy between the gamma characteristics in the vertical direction and the gamma characteristics in the horizontal direction is large. If the gamma characteristics when viewed from the vertical direction and the gamma characteristics when viewed from the horizontal direction differ from each other, it means that the gray scale display conditions vary depending on the viewing directions. This viewing angle dependence of the gamma characteristics causes a serious problem such as the entire display surface appearing more whitened in displaying images such as photos or in displaying television broadcasting received by a receiver, in particular.

As shown in FIG. 3(b), a discrepancy between the gamma characteristics when the display surface is viewed from the frontal direction and the gamma characteristics when viewed from other angles is greater in the gamma characteristics in the horizontal direction than those in the vertical direction. The characteristics indicated by the solid line in the graph shown in FIG. 3(b) are gamma characteristics when the display surface is viewed from the frontal direction, which represent the most normal image appearance. The characteristics indicated by the wider dashed line in the graph shown in FIG. 3(b) are gamma characteristics when the display surface is viewed diagonally from 60°, and there exists a discrepancy between such gamma characteristics and the gamma characteristics of the normal appearance. The degree of the discrepancy is small in ranges corresponding to bright and dark gray scales, and is large in a range corresponding to the intermediate gray scale. That is, when viewed diagonally, the display brightness in the intermediate gray scale becomes significantly high, and as a result, a whitening problem or the like occurs in the diagonal view.

As described above, by the deviation of the orientation directions of the liquid crystal molecules, the balance between the gamma characteristics in the vertical direction and the gamma characteristics in the horizontal direction is worsened. Therefore, when the display surface of the LCD is viewed diagonally, the gray scale display conditions vary depending on the viewing angle, resulting in degradation of display quality of the screen. The size of a region where the deviation of the orientation directions of the liquid crystal molecules occurs does not change regardless of pixel pitch. That is, the smaller the pixel pitch is, the larger the effect of the deviation of the orientation directions becomes.

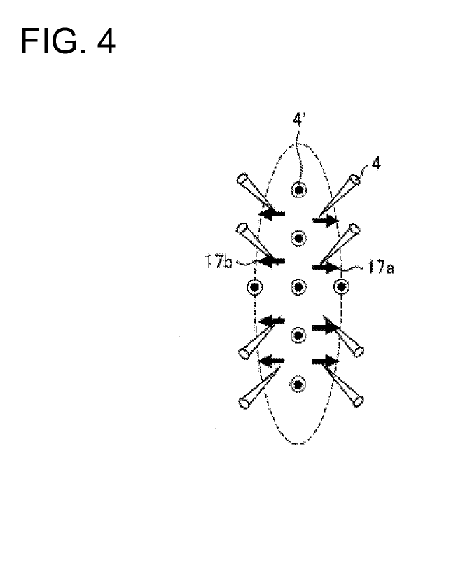

On the other hand, as described above, the pixel electrode 1 according to this embodiment is configured such that the liquid crystal molecules 4 are tilted from the center of the pixel electrode 1 toward the outer circumference of the opposite electrode 9. Further, the pixel 10 is divided into the four domains 5a to 5d such that the liquid crystal molecules 4 are oriented in a plurality of different directions within the single pixel 10. This way, it becomes possible to make the liquid crystal molecules 4 oriented in the four directions that respectively form a 45-degree angle with the polarizing axes of the polarizing plates with high degree of accuracy. Such a configuration is shown in FIG. 4 in detail. FIG. 4 is a diagram showing orientation directions of the liquid crystal molecules 4 in a pixel provided with the pixel electrode 1. The reference character 4′ in this figure represents liquid crystal molecules located in the slit 8. The liquid crystal molecules 4′ line up perpendicularly to the pixel electrode 1 (substrate plane). Specifically, because the liquid crystal molecules 4′ in the slit 8 have no retardation, no orientation direction component is provided therein. That is, the liquid crystal molecules 4′ are not orientated in any other directions but the perpendicular direction to the pixel electrode 1.

As shown in FIG. 4, in the center portion of the pixel electrode 1, the slit 8 is provided (that is, the pixel electrode 1 is not formed), and therefore, the orientation directors of the liquid crystal molecules 4 in the vertical direction are restricted. Thus, by the effects of the frame portion 6 and the fine electrodes 7a to 7d of the pixel electrode 1, in the liquid crystal molecules 4, the orientation directors 17a toward the left and the orientation directors 17b toward the right are increased. As a result, the deviation of the orientation directions of the liquid crystal molecules 4 in each pixel is prevented, thereby improving the balance between the vertical orientation and the horizontal orientation of the liquid crystal molecules 4. This prevents an imbalance of the gamma characteristics caused by the deviation of the orientation directions of the liquid crystal molecules 4.

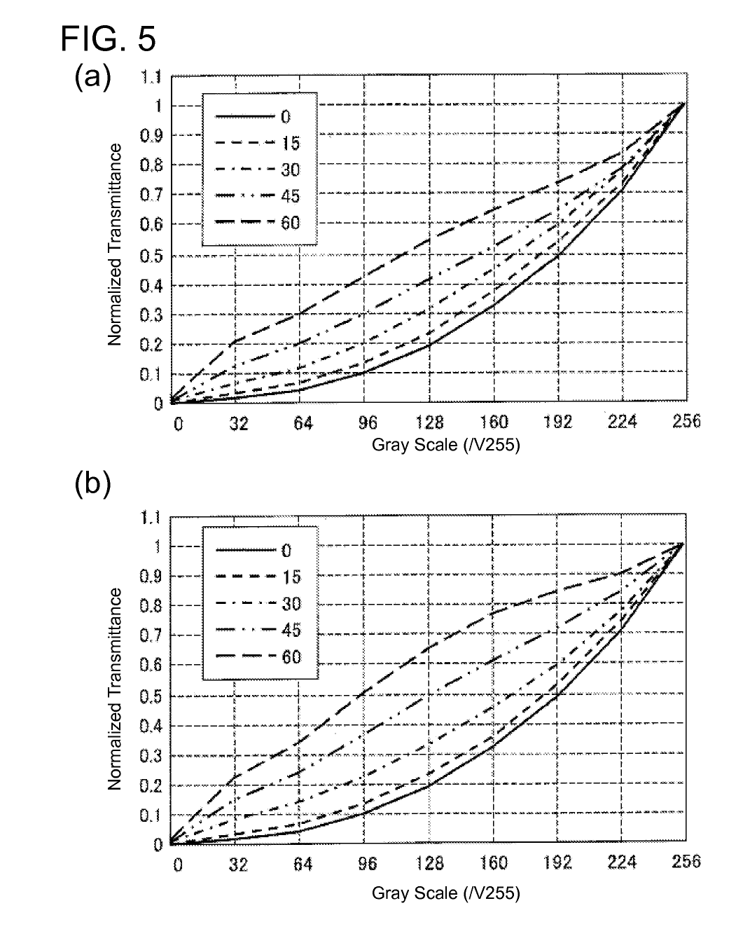

The gamma characteristics in this case is shown in FIG. 5. FIG. 5(a) shows the gamma characteristics in the vertical direction in each pixel 10. FIG. 5(b) shows the gamma characteristics in the horizontal direction in each pixel 10. The horizontal axis in each figure represents a normalized transmittance with the gray scale voltage V255 being 1. In FIG. 5, the gamma characteristics when the display surface is viewed from the frontal direction)(0°), and the gamma characteristics when the display surface is viewed diagonally from 15°, 30°, 45°, and 60° are respectively shown.

As shown in FIGS. 5(a) and 5(b), a discrepancy between the gamma characteristics in the vertical direction and the gamma characteristics in the horizontal direction is small. Because there is almost no difference in the gamma characteristics between when viewed from the vertical direction and when viewed from the horizontal direction, the gray scale display conditions can be prevented from varying depending on the viewing direction. Therefore, in the LCD according to this embodiment, display quality of the display surface can be improved.

Also, as shown in FIG. 5(b), the gamma characteristics when the display surface is viewed from the horizontal direction become similar to the gamma characteristics when the display surface is viewed from the frontal direction. Specifically, the characteristics indicated by the solid line in the graph shown in FIG. 5(b) are the gamma characteristics when the display surface is viewed from the frontal direction, which represent the most normal image appearance. On the other hand, the characteristics indicated by the wider dashed line in the graph shown in FIG. 5(b) are the gamma characteristics when the display surface is viewed diagonally from 60°, and the discrepancy in the brightness between the two characteristics has become smaller. This is because, with the slit 8 formed in the center portion of the pixel electrode 1, the effect of the frame portion 6 and the fine electrodes 7a to 7d of the pixel electrode 1 becomes greater, and therefore, the orientation directors 17a toward the left and the orientation directors 17b toward the right are increased in the liquid crystal molecules 4.

As described above, according to this embodiment, the balance between the gamma characteristics in the vertical direction and the gamma characteristics in the horizontal direction is improved, thereby improving the viewing characteristics in the horizontal direction. This makes it possible to prevent the display gray scale conditions from varying depending on the viewing direction, resulting in further improvement of the display quality of the display surface.

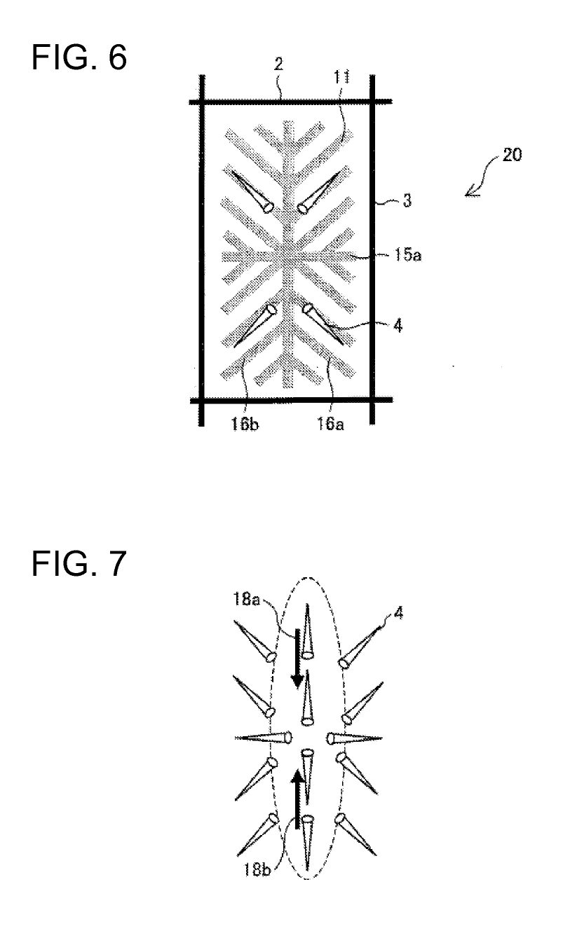

In this embodiment, the slit 8 is formed in the center portion of the pixel 10, and because of the orientation direction of the liquid crystal molecules 4, a light-shielding state is achieved at the boundary portions between the respective domains 5a to 5d. Specifically, as described above, because the liquid crystal molecules 4′ in the slit 8 line up perpendicularly to the pixel electrode 1 (substrate plane), i.e., the liquid crystal molecules 4′ are not oriented in any other directions but the perpendicular direction to the pixel electrode 1, a substantial light-shielding state is achieved. In the pixel electrode of the conventional fishbone structure shown in FIG. 6, for example, the orientation directors 18a toward the top and the orientation directors 18b toward the bottom in the liquid crystal molecules 4 are increased as shown in FIG. 7. As a result, deviation of the orientation directions of the liquid crystal molecules 4 occurs, causing an imbalance between the vertical orientation and the horizontal orientation of the liquid crystal molecules 4 in each pixel. Although the balance can be improved by providing a light-shielding member at the center portion of the pixel (where the liquid crystal molecules 4 with the orientation directors 18a toward the top and the orientation directors 18b toward the bottom are present), it would lower the transmittance aperture ratio of the LCD. However, in this embodiment, because the liquid crystal molecules 4 in the center portion (slit 8) of the pixel line up perpendicularly, there is no need to provide a light-shielding member in this portion. As a result, the reduction in the transmittance aperture ratio of the LCD can be effectively prevented.

The present invention is not limited to the above-mentioned embodiment, and various modifications can be made without departing from the scope defined by the claims. That is, embodiments that can be obtained by combining techniques that have been appropriately modified without departing from the scope defined by the claims are also included in the technological scope of the present invention.

<Summary of Embodiment>

As described above, in the liquid crystal display device according to the present invention, an extending direction of each of the transmittance axes is parallel with or orthogonal to an extending direction of one side of the pixel.

In the liquid crystal display device according to the present invention, the extending direction of each of the transmittance axes is a direction that forms a 45-degree angle with an extending direction of one side of the pixel.

According to this configuration, linear polarized light that entered the liquid crystal layer through one polarizing plate rotates the polarizing axis thereof by the optical polarity rotation and the birefringence of the liquid crystal molecules, and can thereby pass through the other polarizing plate. As a result, excellent viewing characteristics can be obtained.

In the liquid crystal display device according to the present invention, the pixel electrode is divided into four domains.

According to this configuration, the liquid crystal molecules are oriented in four directions that respectively form a 45-degree angle with the respective extending directions of the respective transmittance axes of the polarizing plate. This makes it possible to improve the balance between the gamma characteristics in the vertical direction and the gamma characteristics in the horizontal direction, thereby creating little difference in the gamma characteristics between the vertical view and the horizontal view. As a result, the display gray scale conditions can be prevented from varying depending on the viewing direction, thereby further improving the display quality of the display surface.

In the liquid crystal display device according to the present invention, the pixel electrode is electrically connected to a thin-film transistor.

According to this configuration, by directly connecting the thin-film transistor to the pixel electrode, a loss in a voltage applied to the pixel electrode can be reduced.

The specific embodiments and examples provided in the detailed description of the present invention section are merely for illustrating the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The present invention can be suitably used for a liquid crystal display device that requires high display quality.

### DESCRIPTIONS OF REFERENCE CHARACTERS

1, 11 pixel electrode
2 scanning line
3 signal line
4, 4′ liquid crystal molecule
5a to 5d domain
6 frame portion
7a to 7d fine electrode
8 slit
9 opposite electrode
10, 20 pixel
12 opposite substrate
13 TFT substrate
15a, 15b trunk portion
16a, 16b branch portion
17a, 17b, 18a, 18b orientation director

1. A liquid crystal display device of a vertical alignment type that has a plurality of pixels and a pair of polarizing plates disposed such that transmission axes thereof are orthogonal to each other, comprising:
a pixel electrode; an opposite electrode facing the pixel electrode; and a liquid crystal layer disposed between the pixel electrode and the opposite electrode in each of said plurality of pixels,
wherein the pixel electrode are divided into a plurality of domains, and comprises a frame portion along an entire inner circumference of the pixel and a plurality of fine electrode portions each having one end connected to the frame portion and another end separated therefrom, the plurality of fine electrode portions being extended toward an inside of the frame portion,
wherein the plurality of fine electrode portions are extended in a same direction in each of said domains, and an extending direction thereof differs from an extending direction of the plurality of fine electrode portions provided in another domain, and
wherein each of the fine electrode portions is extended in a direction that forms a 45-degree angle with respective extending directions of the transmission axes.

2. The liquid crystal display device according to claim 1, wherein each of the extending directions of the transmission axes is parallel with or orthogonal to an extending direction of one side of the pixel.

3. The liquid crystal display device according to claim 1, wherein the extending directions of the transmission axes respectively form a 45-degree angle with an extending direction of one side of the pixel.

4. The liquid crystal display device according to claim 1, wherein the pixel electrode is divided into four domains.

5. The liquid crystal display device according to claim 1, wherein the pixel electrode is electrically connected to a thin-film transistor.
